(19) United States
(12) Patent Application Publication
(10) Pub. No.: US 2023/0385541 A1
(43) Pub. Date: Nov. 30, 2023

(54) METHOD AND SYSTEM FOR PRODUCING UNIFIED NATURAL LANGUAGE PROCESSING OBJECTS

(71) Applicant: One AI, Inc., San Francisco, CA (US)

(72) Inventors: Amit BEN SHAHAR, Herzelia (IL); Yosef Asi SHEFFER, Tel Aviv (IL)

(21) Appl. No.: 17/827,728

(22) Filed: May 29, 2022

(51) Int. Cl. G06F 40/20; G06F 40/169; G06F 3/0482; G06F 3/0484

(52) U.S. Cl. CPC G06F 40/20; G06F 40/169; G06F 3/0482; G06F 3/0484; G06F 2203/04803

(57) ABSTRACT

Computer implemented method and user interface for enabling streamlined text language processing utilizing a plurality of ML and/or NLP models by standardization of all input/out components.

### TECHNOLOGICAL FIELD

The present disclosure generally relates to a system and method for processing a text using a variety of machine learning (ML) and/or natural language processing (NLP) models, in particular for producing a unified input/output protocol enabling seamless usage of the variety of models.

### BACKGROUND

Processing text typically involves different types of operations (such as analysis, data extraction, interpretation, editing, fixing, annotating and writing). Each of these operations often require implementing and executing various different solutions, such as ML models, computer programs and algorithms, each requiring its own specific input/output format and usage protocol.

The varied nature of suitable models, their diverse interfaces, and the tendency of any kind of useful processing to require a multiplicity of such models in different combinations, renders the integration of the models into a logical flow of a computer program (or product) difficult, labor intensive, and require expertise.

Typically, a dedicated code for invoking each step involves translation functions for each component pair. For example, in process A->B->C, an implementation will be required for translating output protocol of component A to input protocol of component B, and for translating output protocol of component B to input protocol of component C, and finally translating output of component C to a usable format required by the product or code invoking the process.

Moreover, the lack of a unified protocol requires that a unique custom-used program that adapts the specific components and solutions used be written and any change requires adaptations to the program, which may be difficult and at times even impossible in the case of already deployed solutions.

There therefore remains a need for a system and method that enables utilization of a variety of language AI models intended to process, through a common and shared input/output protocol, both internally between multiple components in a processing flow (pipeline) and between a host program and the utilized solutions/flow.

### SUMMARY

Aspects of the disclosure, according to some embodiments thereof, relate to systems, platforms and methods that enable text language processing utilizing a plurality of ML models (e.g. one or more NPLs).

In short, the herein disclosed systems, platforms and methods establish that AI language solutions can be represented by one or more of three distinct operations:
1. Changing of a text (add/edit/delete sections of text)
2. Adding metadata on spans of text (entity values, highlights, keywords, topic segments etc.); and
3. Providing vector representation of text spans, usually either embeddings, or model inference vectors (e.g. Attention vectors).

These operations and their output can be represented by a standardized data structure and/or protocol comprising:
a. a text segment,
b. a collection of data labels, each label referring to the whole text or a span (part) of the text, and adding information representing the text span, wherein the information can include:
   i. Label name—representing the type of label and how to interpret its value;
   ii. Value (e.g. numeric, date, textual, vector).

Accordingly, the operations can be represented by a simple data structure in that each component accepts as input, and outputs two elements: a text-block, and a collection of properties (label and value) relating to spans of the text block.

Initially, a specific use-case for text processing and the required steps to achieve the required results is identified and the required components/models/functions of each step of the processing as well as the supported input and output protocol for each such component is outlined.

It is known to one of skill in the art that different components differ in their input format, such that they almost never match the exact input/output format of other models. Accordingly, translations are required.

Typically, the translation issue is solved by directly translating each input/output pair for all components. However, such user-case translations eventually lead to poor operational efficiency and high costs of execution, inter alia because common or shared steps are repeatedly executed for each implementation, as dependencies are not shared and are usually unknown. Moreover, such direct pair-wise translations also increase the complexity of code maintenance and the long-term cost of building and deploying its components.

Advantageously, the herein disclosed systems, platforms and methods provide a standardized/shared protocol or format that enables flexible organization and execution of various NLP tasks, as further elaborated herein. This simplifies NLP processing and product integration, by providing a single-point of entry ‘pipeline’ API, which allows invoking and chaining multiple skills to process an input text, all with a single API call.

When NLP components are translated into a shared and standardized input/output protocol it allows easy and seamless combinations of components, resulting in faster time for experimentation and value creation. It also allows a non-technical user to combine highly technical components without requiring an understanding of underlying mechanisms and implementation details. This advantageously opens the door for exposing NLP capabilities to non-NLP-experts.

As NLP capabilities (and many advanced AI/ML capabilities) tend to be comprised of multiple processing steps (including machine learning models, mathematical algorithms, logical algorithms, etc.), it is also common for advanced NLP capabilities to rely on other NLP capabilities to function, in a sort of hierarchical dependency.

For example, an NLP capability of extracting keywords from a text may depend on an NLP model designed to summarize the text, which outputs the most important segment(s) of the text and their mathematical and semantic representations, from which the keywords are extracted—i.e. the ‘keyword extraction’ NLP component is dependent on the ‘summarize text’ NLP component.

Accordingly, if a user seeks to obtain an output including both ‘summarize text’ and ‘keyword extraction’ components, this can be obtained using a single execution pipeline that automatically orders the execution of the components in an optimal sequence (summarize->highlights) while leveraging the fact that the dependency of the components is known, and the input/output standardized, hence the output of the intermediate step can be aggregated with the final step providing both outputs.

Moreover, the herein disclosed systems, platforms and methods advantageously allow joined dependencies to be executed once, while providing output to multiple components by subsequent decoupling of dependencies and reorganization of execution nodes. Accordingly, NLP components and/or sub-components can be combined to create higher level components without requiring writing new code.

According to some embodiments, there is provided a processing logic configured to:
receive an input from a user, the input comprising:
   a text containing document,
   one or more user selected Natural Language Processing (NLP) tasks (skills) to be executed on the text containing document; and
   a user selected hierarchy of the selected NLP tasks, wherein the hierarchy of the user selected NLP tasks dictates an execution order and/or execution dependency between the selected NLP tasks
generate an NLP execution plan by:
   identifying one or more machine learning (ML) and/or NLP models required for execution of each of the selected NLP tasks (skill),
   generating a first NLP object based on the inputted text-containing document and the user selected hierarchy of selected NLP tasks,
   generating one or more subsequent NLP object, using the first NLP object as an input
   wherein the first and the one or more subsequent NLP objects comprise the text-containing document and a collection of metadata items, wherein each metadata item comprises a) a type of annotation, and b) one or more metadata item features selected from: a span of the text containing document upon which the metadata is applied, a primary value of the annotation, and one or more additional associated annotation values,
   wherein each of the required ML and/or NLP models receive an NLP object as an input and wherein each of the required ML and/or NLP models outputs an NLP object;
aggregating the NLP objects resulting from execution of all NLP tasks considering their position in the execution hierarchy; and
generating one or more final outputs in a form of a modified text and/or in a form of a list of extracted metadata associated with the inputted text-containing document or with the modified text.

According to some embodiments, the aggregating of the NLP objects comprises identifying shared and/or interdependent components, subcomponents and/or processing steps in the one or more required ML/NLP models.

According to some embodiments the aggregating of the NLP objects further comprises merging and/or unifying the shared and/or interdependent components, subcomponents and/or processing steps, to avoid repetition thereof.

According to some embodiments, generating the NLP execution plan further comprises determining a source and/or a type of the text-containing document inputted.

According to some embodiments the source of the text-containing document inputted is selected from a transcribed text, a paper, a bot chat, a one-pager, a business presentation, an article, a written conversation, a blog, a recorded and transcribed conversation, news, text message or any combination thereof. Each possibility is a separate embodiment.

According to some embodiments, the one or more selected NLP tasks is selected from: creating a text summary, identifying highlights in the text, identifying emotions in the text, identifying sentiments in the text, identifying keywords, split text, clustering, topic extraction, entity detection, identifying, enhance transcription or any combination thereof. Each possibility is a separate embodiment.

According to some embodiments, the one or more ML/NLP models is selected from Bidirectional Encoder Representations from Transformers (BERT), Robustly Optimized BERT Pretraining Approach (RoBERTa), GPT-3, ALBERT, XLNet, GPT2, StructBERT, Text-to-Text Transfer Transformer (T5), Efficiently Learning an Encoder that Classifies Token Replacements Accurately (ELECTRA), Decoding-enhanced BERT with disentangled attention (DeBERT) or any combination thereof. Each possibility is a separate embodiment.

According to some embodiments, the modified text comprises text changes and/or metadata representations and/or vector representations.

According to some embodiments, the text changes comprise text additions, text editions and/or text deletions. According to some embodiments, the metadata comprises labeling the inputted text or one or more spans thereof with one or more labels selected from: annotation name, annotation, span of the text containing document upon which the metadata is applied, a primary value of the annotation, and one or more additional associated annotation values. According to some embodiments, the vector representations comprise embeddings and/or interference vectors.

According to some embodiments, the list of extracted metadata comprises a type of NLP task, a label of the NLP task, a span of the NLP task, a value of the NLP task or any combination thereof. Each possibility is a separate embodiment.

According to some embodiments, there is provided a user interface configured to:
receive an input from a user, the input comprising:
a text-containing document,
one or more user selected Natural Language Processing (NLP) tasks (skills) to be executed on the text containing document; and
a user selected hierarchy of the selected NLP tasks, wherein the hierarchy of the user selected NLP tasks dictates an execution order and/or execution dependency between the selected NLP tasks; and
generate one or more NLP outputs in a form of a modified text and/or a list of extracted metadata associated with the inputted text and/or with the modified text.

According to some embodiments, the text-containing document is a conversation type text or an article type text.

According to some embodiments, the text containing-document inputted is selected from a transcribed text, a paper, a bot chat, a one-pager, a business presentation, an article, a written conversation, a blog, a recorded and transcribed conversation, news, text message or any combination thereof. Each possibility is a separate embodiment.

According to some embodiments, the one or more selected NLP tasks is selected from: creating a text summary, identifying highlights in the text, identifying emotions in the text, identifying sentiments in the text, identifying keywords, split text, clustering, topic extraction, entity detection, identifying, enhance transcription or any combination thereof. Each possibility is a separate embodiment.

According to some embodiments, the list of extracted metadata comprises a type of NLP task, a label of the NLP task, a span of the NLP task, a value of the NLP task or any combination thereof. Each possibility is a separate embodiment.

According to some embodiments, the user interface comprises two windows, wherein a first of the two windows comprises an input-side and wherein a second of the two windows comprises an output-side. According to some embodiments, the two windows may be positioned side by side.

According to some embodiments, the input-side comprises one or more user modifiable input-sub-windows. According to some embodiments, the one or more input sub-windows comprise a text input window, a generated code window and an NLP-task window.

According to some embodiments, the output side-window comprises one or more output-sub-windows. According to some embodiments, the one or more output-sub-windows comprise a text window and/or a list of extracted metadata-window.

Certain embodiments of the present disclosure may include some, all, or none of the above advantages. One or more other technical advantages may be readily apparent to those skilled in the art from the figures, descriptions, and claims included herein. Moreover, while specific advantages have been enumerated above, various embodiments may include all, some, or none of the enumerated advantages.

### BRIEF DESCRIPTION OF THE FIGURES

Some embodiments of the disclosure are described herein with reference to the accompanying figures. The description, together with the figures, makes apparent to a person having ordinary skill in the art how some embodiments may be practiced.

In block diagrams and flowcharts, certain steps may be conducted in the indicated order only, while others may be conducted before a previous step, after a subsequent step or simultaneously with another step. Such changes to the orders of the step will be evident for the skilled artisan.

FIG. 1 is a flowchart of the herein disclosed computer implemented method for enabling streamlined text language processing utilizing a plurality of ML and/or NLP models by standardization of all input/out components, according to some embodiments;

FIG. 2A is a flow chart depicting the NLP tasks execution required for extracting entities, keywords and topics for a given text, using conventional methods;

FIG. 2B is a flow chart depicting the NLP tasks execution required for extracting entities, keywords and topics for a given text, using the herein disclosed method;

FIG. 3A and FIG. 3B which illustratively depict an optional pipeline of the herein disclosed computer implemented method for enabling streamlined text language processing utilizing a plurality of ML and/or NLP models for a conversation type document, according to some embodiments;

FIG. 4A and FIG. 4B which illustratively depict an optional pipeline of the herein disclosed computer implemented method for enabling streamlined text language processing utilizing a plurality of ML and/or NLP models for an HTML extracted article type document, according to some embodiments.

### DETAILED DESCRIPTION

The principles, uses and implementations of the teachings herein may be better understood with reference to the accompanying description and figures. Upon perusal of the description and figures present herein, one skilled in the art will be able to implement the teachings herein without undue effort or experimentation. In the figures, same reference numerals refer to same parts throughout.

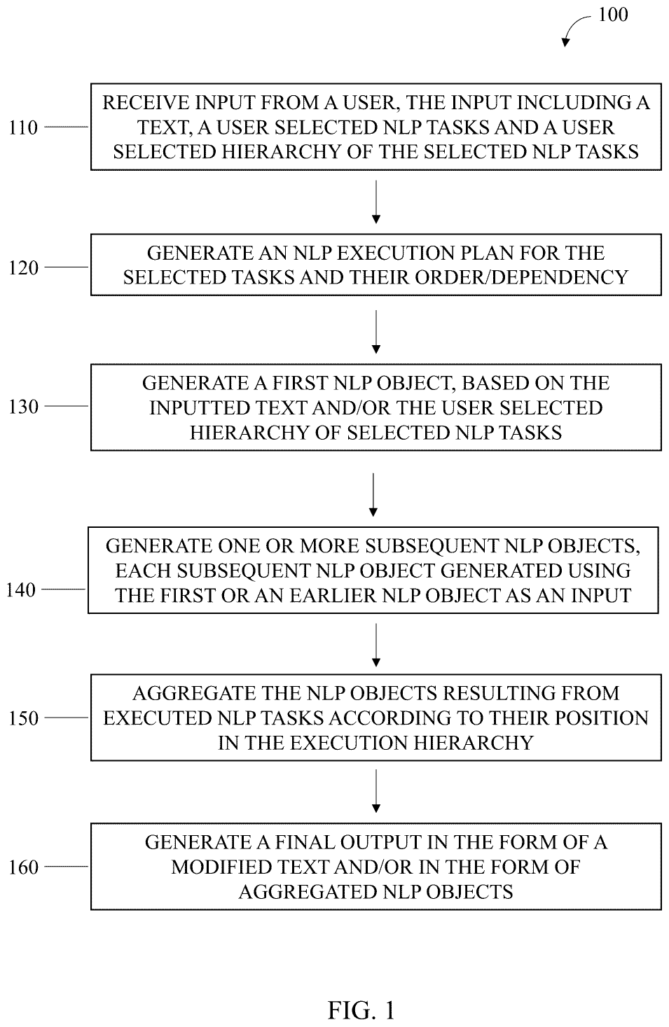

Reference is now made to FIG. 1, which is a flow chart 100 of the herein disclosed computer implemented method for enabling streamlined text language processing utilizing a plurality of ML and/or NLP models by standardization of all input/out components.

As used herein the terms “machine learning” and ML may be used interchangeably and refer to computer algorithms that can improve automatically through experience and by the use of data. It is seen as a part of artificial intelligence. ML algorithms build a model based on sample data, known as training data, in order to make predictions or decisions without being explicitly programmed to do so.

As used herein the terms “natural language processing” and “NLP” may be used interchangeably and refer to the ability of a computer program to understand human language as it is spoken and written—referred to as natural language. It is a subfield of linguistics, computer science, and artificial intelligence concerned with the interactions between computers and human language, in particular how to program computers to process and analyze large amounts of natural language data. The goal is a computer capable of “understanding” the contents of documents, including the contextual nuances of the language within them. The technology can then accurately extract information and insights contained in the documents as well as categorize and organize the documents themselves. It is a component of artificial intelligence (AI). Natural language processing uses artificial intelligence to take real-world input, process it, and make sense of it in a way a computer can understand.

According to some embodiments, there are two main phases to natural language processing: data preprocessing and algorithm development.

According to some embodiments, data preprocessing involves preparing and “cleaning” text data for machines to be able to analyze it. Preprocessing puts data in workable form and highlights features in the text that an algorithm can work with. There are several ways this can be done, including:
Tokenization. This is when text is broken down into smaller units to work with.
Stop word removal. This is when common words are removed from text so unique words that offer the most information about the text remain.
Lemmatization and stemming. This is when words are reduced to their root forms to process.

According to some embodiments, once the data has been preprocessed, an algorithm is developed to process it. There are many different natural language processing algorithms, but two main types are commonly used:
Rules-based system: This system uses carefully designed linguistic rules. This approach was used early on in the development of natural language processing and is still used.
Machine learning-based system: Machine learning algorithms use statistical methods. They learn to perform tasks based on training data which they are fed, and adjust their methods as more data is processed. Using a combination of machine learning, deep learning and neural networks, natural language processing algorithms hone their own rules through repeated processing and learning.

According to some embodiments, techniques and methods of natural language processing may include:
Syntax and semantic analysis are two main techniques used with natural language processing. Syntax is the arrangement of words in a sentence to make grammatical sense. NLP uses syntax to assess meaning from a language based on grammatical rules. Syntax techniques include:
   Parsing i.e. the grammatical analysis of a sentence by breaking sentences into parts of speech, such as nouns, verbs etc.
   Word segmentation: The act of taking a string of text and deriving word forms from it.
   Sentence breaking: This places sentence boundaries in large texts such as periods that split up sentences.
   Morphological segmentation. This divides words into smaller parts called morphemes.
   Stemming: Divides words with inflection in them to root forms which enables analyzing a text for all instances of a word, as well as all of its conjugations.
Semantics: The use of and meaning behind words. NLP applies algorithms to understand the meaning and structure of sentences. Semantics techniques include:
   Word sense disambiguation: This derives the meaning of a word based on context.
   Named entity recognition: This determines words that can be categorized into groups. For example, an algorithm using this method could analyze a news article and identify all mentions of a certain company or product. Using the semantics of the text, it would be able to differentiate between entities that are visually the same.
   Natural language generation: This uses a database to determine semantics behind words and generate new text. For example, an algorithm may automatically write a summary of findings of a text, while mapping certain words and phrases to features of the data in the input text. As another example, the NLP may automatically generate new text forms, e.g. based on a certain body of text used for training.

According to some embodiments, natural language processing is based on deep learning, which examines and uses patterns in data to improve a program's understanding. Deep learning models require massive amounts of labeled data for the natural language processing algorithm to train on and identify relevant correlations. Assembling big data sets is one of the main hurdles to natural language processing. Additionally or alternatively, the natural language processing involves a rules-based approach, where simpler ML algorithms are told what words and phrases to look for in a text and given specific responses when those phrases appear.

Three tools used commonly for natural language processing include Natural Language Toolkit (NLTK), Gensim and Intel natural language processing Architect. NLTK is an open-source Python module with data sets and tutorials. Gensim is a Python library for topic modeling and document indexing. Intel NLP Architect is another Python library for deep learning topologies and techniques.

According to some embodiments, the one or more NLP models may include one or more autoregressive language models. According to some embodiments, the one or more NLP may be selected from: Bidirectional Encoder Representations from Transformers (BERT), Robustly Optimized BERT Pretraining Approach (RoBERTa), GPT-3, ALBERT, XLNet, GPT2, StructBERT, Text-to-Text Transfer Transformer (T5), Efficiently Learning an Encoder that Classifies Token Replacements Accurately (ELECTRA), Decoding-enhanced BERT with disentangled attention (DeBERT) or any combination thereof. Each possibility is a separate embodiment.

According to some embodiments, in step 110 of the computer implemented method an input is received from a user, e.g. through a user interface.

According to some embodiments, the input comprises a) a text segment; b) one or more user selected NLP tasks which the user wants to be executed on the text segment; and c) a user selected hierarchy of the selected NLP tasks, which hierarchy dictates an execution order and/or execution dependency between the selected NLP tasks. According to some embodiments, the user input may be provided through a JSON, phyton, CURL or Node.j s code. Each possibility is a separate embodiment.

As used herein, the terms “text” and “text segment” may be used interchangeably and may refer to any form of written media, such as, but not limited to, transcribed text, a paper, a bot chat, a one-pager, a business presentation, an article, a written conversation, a blog, a recorded and transcribed conversation, text messages, social media content, news or any combination thereof. Each possibility is a separate embodiment.

According to some embodiments, two main types of text can be provided, namely i) documents having the attribute of being a text (any text that does not have a structural format) and ii) conversations which optionally include an utterance list for each speaker and its fields.

As used herein, the term “text span” refers to a portion of the inputted text and/or modified versions thereof.

As used herein, the term “NLP task”, “NLP skill” and “annotation” may be used interchangeably and may refer to capabilities and assignments related to text processing, such as but not limited to:
Identifying highlights: Detects key sentences within texts. The results can provide immediate insights on texts, helping to skim through large amounts of entries quickly. According to some embodiments, this may include posting a request to generate highlights such as:

{
“text”: “your input text here”,
“steps”: [
{ “id”: “1”, “skill”: “highlights”, “input”: “0” }
]
}

The response being an output highlighting sentences in the inputted text segment.
Enhance transcription: Automatic transcriptions are often messy. Spoken language is informal and contains filler words, and meaning is sometimes lost.

Enhance Transcription makes transcripts more usable, by removing fluff and fixing errors. The enhanced transcription can then be reviewed or further processed by other Language Skills According to some embodiments, this may include posting a request to generate highlights, such as:

{
“text”: “your input text here”,
“steps”: [
{ “id”: “1”, “skill”: “enhance”, “input”: “0” }
]
}

The output being an enhanced transcription and spans of the replaced text.
Sentiment detection: The Sentiment Detection Skill detects and labels parts of texts that have positive or negative sentiment. Large-scale sentiment analysis can be done to discover trends, understand the perception of a subject in social media, etc.

According to some embodiments, this may include posting a request to generate highlights, such as:

{
“text”: “your input text here”,
“steps”: [
{ “id”: “1”, “skill”: “sentiment”, “input”: “0” }
]
}

The output being a span of text and its classification as having a positive or a negative sentiment.
Keyword detection: The Keyword Detection Skill locates and labels essential words within the inputted text. The results can help to tag articles and tickets or analyze large amounts of data to determine which keywords appear frequently. According to some embodiments, this may include posting a request to generate highlights, such as:

{
“text”: “your input text here”,
“steps”: [
{ “id”: “1”, “skill”: “keywords”, “input”: “0” }
]
}

The output being keyword labels for the inputted text.
Summarize: Summarize creates context-aware summarizations of texts. The results are concise and contain all the relevant information, and can be used in conjunction with other Language Skills to improve results by processing only the key information.

According to some embodiments, this may include posting a request to generate highlights, such as:

{
“text”: “your input text here”,
“steps”: [
{ “id”: “1”, “skill”: “summarize”, “input”: “0” }
]
}

The output being a summary for the inputted text.
Sentence Split: Split into sentences takes a bulk of text and splits it into sentences. The results can then be further processed by other Language Skills, to analyze the text by sentence.

According to some embodiments, this may include posting a request to generate highlights, such as:

{
“text”: “your input text here”,
“steps”: [
{ “id”: “1”, “skill”: “sentences”, “input”: “0” }
]
}

The output being the inputted text cut into sentences.
Topic Split: Takes a bulk of text and splits it into segments discussing/referencing a shared topic/s. For example, a conversation may start with ‘Introductions’, then a ‘product demo’, followed by a ‘pricing discussion’ and ‘next steps and process’. The results can then be further processed by other Language Skills, to analyze the text by segment.

According to some embodiments, this may include posting a request to generate highlights, such as:

{
“text”: “your input text here”,
“steps”: [
{ “id”: “1”, “skill”: “topic-split”, “input”: “0” }
]
}

The output being the inputted text cut into sentences.
Topic extraction: Topic Extraction reads texts and labels them with a set of relevant topics, such as, but not limited to ‘Sports’, “space technology”, “Machine learning”. Using these topics you can organize large amounts of text data, and route text entries to the right destination.

According to some embodiments, this may include posting a request to generate highlights, such as:

{
“text”: “your input text here”,
“steps”: [
{ “id”: “1”, “skill”: “topic”, “input”: “0” }
]
}

The output being a set of corresponding topics for the inputted text.
Entity detection: The Entity Detection skill finds and labels entities (e.g. dates, numbers or the like) within texts. The results can help generate action items or analyze a large amount of data to determine which entities appear frequently.

According to some embodiments, this may include posting a request to generate highlights, such as:

{
“text”: “your input text here”,
“steps”: [
{ “id”: “1”, “skill”: “entities”, “input”: “0” }
]
}

The output being entity labels, such as, but not limited to (each possibility being a separate embodiment):
   PERSON: People, including fictional ones.
   NORP: Nationalities or religious or political groups.
   FAC: Companies, agencies, institutions, etc.
   GPE: Countries, cities, states.
   LOC: Non-GPE locations, mountain ranges, lakes
   Non-GPE locations, mountain ranges, lakes
   PRODUCT: Objects, vehicles, foods, etc.
   EVENT: Hurricanes, battles, sports events, etc.
   WORK OF ART: Titles of books, songs, etc.
   LAW: Named documents made into laws.
   LANGUAGE: Any named language.
   DATE: Absolute or relative dates or periods.
   PERIOD: Absolute or relative dates or periods.
   TIME: Times smaller than a day.
   PERCENT: Percentage, including “%”.
   MONEY: Monetary values, including unit.
   QUANTITY: Measurements, as of weight or distance.
   ORDINAL: “first”, “second”, etc.
   CARDINAL: Numerals that do not fall under another type.
Emotion detection: The Emotion Detection skill detects emotions conveyed within texts. The results can be used to discover how people feel about certain subjects, analyze customer service calls, chat logs, and measure the objectivity of the text.

According to some embodiments, this may include posting a request to generate highlights, such as:

{
“text”: “your input text here”,
“steps”: [
{ “id”: “1”, “skill”: “emotions”, “input”: “0” }
]
}

The output being detected emotion labels in the supplied text/conversation, such as, but not limited to, (each possibility being a separate embodiment): happiness, sadness, surprise, fear and anger.
Clustering: The Clustering Language skill takes a list of text entries and clusters together similarly meaning texts. Clusters are generated on-the-go, based on intent identified in the text entries. The clusters can be used to review, analyze and understand large amounts of text entries, such as customer service tickets, social media posts, chat messages and product reviews.

According to some embodiments, this may include posting a request to generate highlights, such as:

{
“text”: “your input text here”,
“steps”: [
{ “id”: “1”, “skill”: “clustering”, “input”: “0” }
]
}

The output being a list of generated clusters.

Other suitable NLP tasks include: Text classification/Document Classification, assigning a text/document to one or more classes or categories, such as, but not limited to, Document Ranking, Machine translation, question generation, image captioning, fake news detection, hate speech detection, sales process indicators, contract highlights (parties, payment, termination terms, liability, etc.), writing quality assessment, writing style detection, article title creation, generated text proof-reading, entity enrichment, entity relations detection and any combination thereof.

According to some embodiments, the NLP task can be categorized as a generator skill or an analyzer skill. According to some embodiments, a generator skill changes the input text and the NLP object is the modified text. Non-limiting examples of generator skills include transcription enhancer and text summarizer. According to some embodiments, an analyzer skill annotates/analyzes the inputted text, and the output is a list of labels (metadata) generated by the analyzer skill. Non-limiting examples of analyzer skills include emotion identifier, entity identifier and keyword extractor.

As used herein, the term “hierarchy” with respect to the selected NLP tasks, refers to the order of the execution of the NLP task and/or their dependency.

For example, if the user selects that he/she wants to summarize the inputted text and then extract keywords, the NLP capability of extracting keywords depends on an NLP model capable of summarizing the inputted text. If the user further wants to detect emotions in the summarized text, the emotion detection NLP also depends on the summary and, in that way, shares the same input as the keyword extraction NLP, but the NLP itself may be independent from the keyword extraction NLP, in terms of processing.

According to some embodiments, in step 120, the computer implemented method then generates an NLP execution plan for the selected task and their order/dependency requested by the user by identifying tasks sharing the same input, depending on a previous output, and/or tasks sharing components and/or processing steps.

According to some embodiments, generating the execution plan may include identifying one or more ML and/or NLP models required for execution of each of the selected NLP tasks.

According to some embodiments, in step 130, the computer implemented method generates a first NLP object, based on the inputted text and, optionally, also on the user-selected hierarchy of selected NLP tasks.

As used herein, the term NLP object may refer to the output of an NLP task. According to some embodiments, the NLP object may contain a) an input text either the original input or text produced by a previous NLP task and b) List of labels—detected by the NLP task that contain the extracted data. According to some embodiments, the NLP object may optionally only contain extracted metadata (in the form of structured reference data that helps to sort and identify attributes of the information it describes).

According to some embodiments, the first NLP object may include assigning metadata to the inputted text prior to the execution of the selected NLP task. As a non-limiting example, the first NLP object may refer to categorization of the type of text as a document or as a conversation, and assigning respective attributes accordingly. This may contribute to the processes of selecting the appropriate variations/parameters of execution of some or all of the requested skills

According to some embodiments, in step 140, the computer implemented method then generates one or more subsequent NLP objects, each subsequent NLP object generated using the first or an earlier NLP object (of the subsequent NLP objects) as an input (as further elaborated herein below).

According to some embodiments, the NLP objects include a text segment and a collection of metadata items. According to some embodiments, each metadata item comprises a type of annotation (e.g. entities), and one or more metadata item features selected from: a span of the text segment upon which the feature is applied (for example by underlining the part of the inputted text), a primary value of the annotation, for example, measurement of weight in kilo, and one or more additional associated annotation values (for example, weight measurement in pounds).

According to some embodiments, each of the required ML and/or NLP models receive the first NLP object or a subsequently generated NLP object (e.g. an NLP object in the form of a summarized text as an input).

According to some embodiments, each of the required ML and/or NLP models output an NLP object based on the skill performed thereon.

According to some embodiments, in step 150, the computer implemented method may then aggregate all the NLP objects resulting from all executed NLP tasks according to their position in the execution hierarchy.

According to some embodiments, the aggregating of the NLP objects includes identifying shared and/or interdependent components, subcomponents and/or processing steps in the one or more required ML/NLP models. For example, if more than one NLP task depends on the same input, the input can be provided simultaneously to the different NLP tasks for parallel execution. Similarly, if a text span contains more than one annotation, these can be provided together on the text span.

According to some embodiments, the aggregating of the NLP objects may further include merging/unifying the shared and/or interdependent components, subcomponents and/or processing steps, to avoid repetition thereof. For example, if an NLP object serves as an input for several NLP tasks, the summary may be executed once and provided to all dependent NLP tasks instead of summarizing for each NLP task separately. Similarly, if multiple NLP tasks depend on a common underlying requirements, such as vectorization of the text using an Embedding Model, tokenization, dependency parsing, shared layers of a neural network, share processing steps of a machine learning model or other task implementation components/sub-components, merging of the unidirectional execution graph by identifying shared steps from a common input, a single execution of the unified shared steps and subsequent forking of execution for non-unified steps may be executed. This can happen in multiple positions in the execution process/graph.

For example, a product aiming to extract Entities, Keywords and Topics for a given text, would normally execute each such NLP task independently, unaware of the shared dependencies of external sub-components (such as a tokenizer) and interdependencies between tasks—such as Topics tasks internally dependent on both Entities & Keyword extraction.

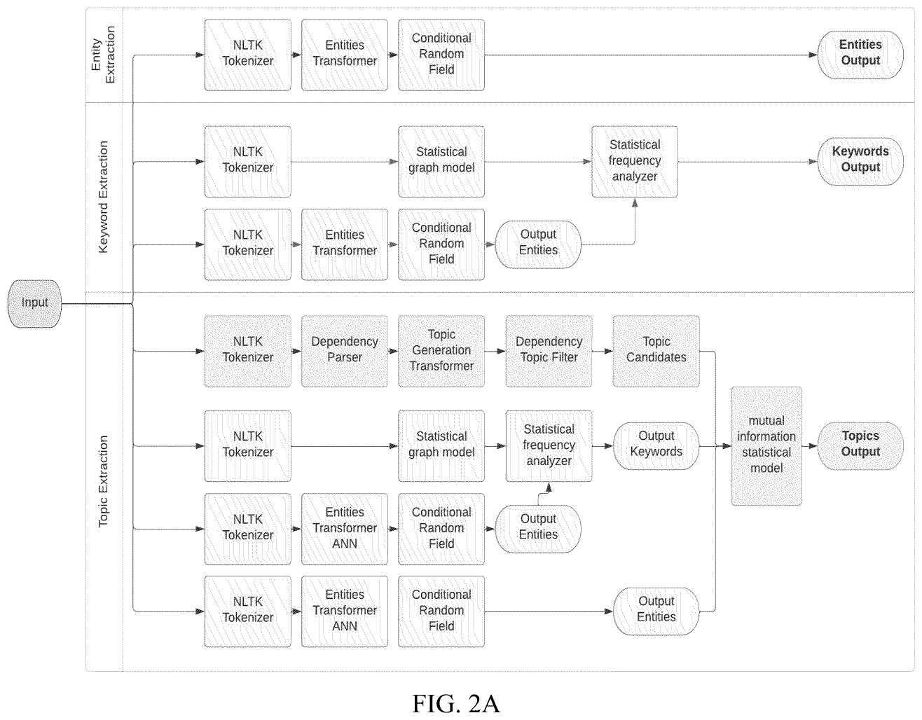

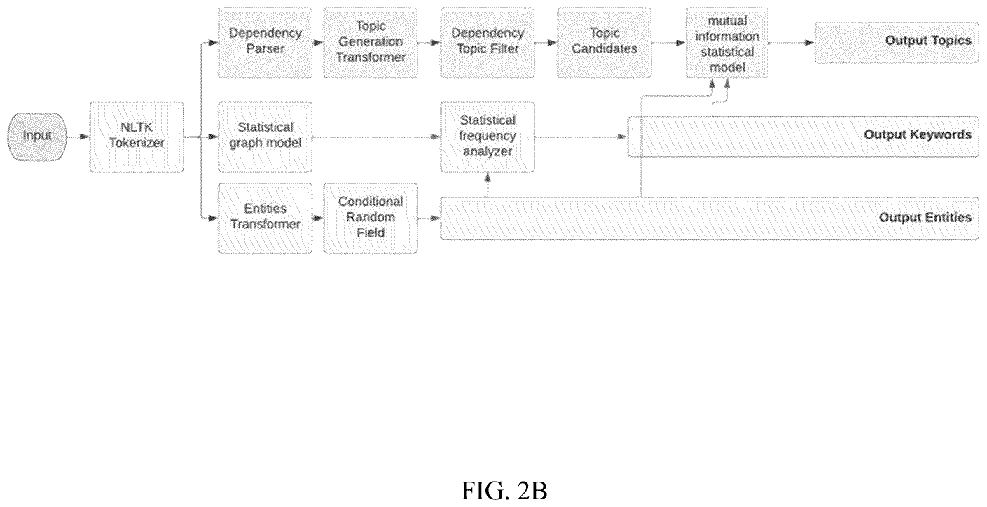

This means that, as exemplified in FIG. 2A, using currently available methods, NLTK Tokenizer will be executed up to a total of 7 times, Entities Transformer executed 4 times, Keywords statistical analyzer 2 times and so on.

On the contrary, when applying the herein disclosed logic of mutual dependencies in the pipeline, and metadata identification of joint NLP model dependencies according to a given list of NLP tasks, the execution graph is advantageously reduced to a single execution for each pair of input+component, as set forth in FIG. 2B.

According to some embodiments, in step 160, the computer implemented method may then generate one or more final output(s) in the form of a modified text and/or in the form of aggregated NLP objects (metadata).

According to some embodiments, the final input is dynamic. For example, the user may rearrange the hierarchy to create a new final output (e.g. request keywords from original text instead of summarized text). As another example, the user may add and/or delete NLP tasks. As another example, the user may request to view certain NLP tasks separately e.g. one by one on the originally inputted text or on a text produced during execution of an earlier NLP task upon which it depends (e.g. the text after enhanced transcription skill has been applied)

### Examples

### Example 1—NLP tasks on chat bot conversation

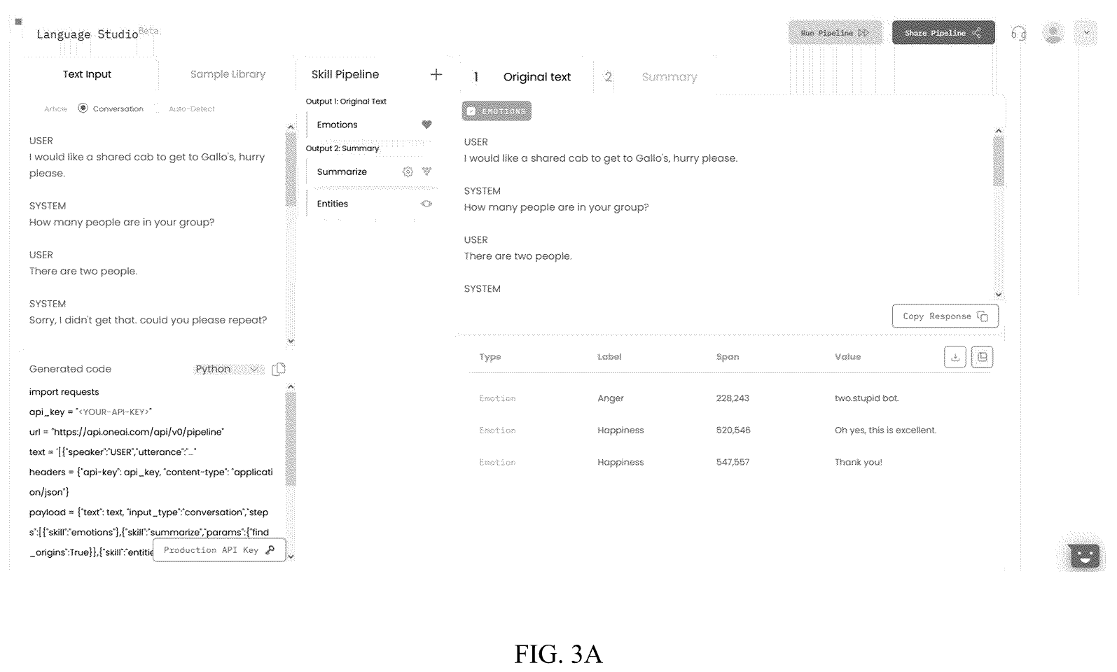

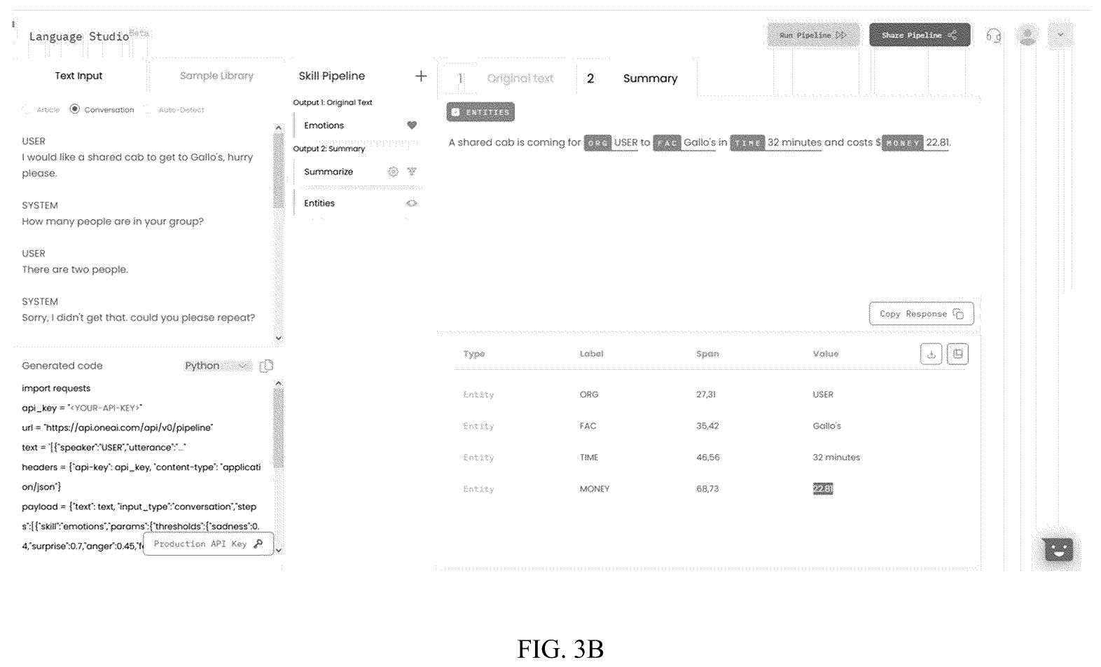

Reference is now made to FIG. 3A and FIG. 3B, which illustratively depict an optional pipeline of the herein disclosed computer implemented method for enabling streamlined text language processing utilizing a plurality of ML and/or NLP models for a conversation type document, according to some embodiments.

First a user may insert the text, in this case a chatbot conversation. For example:
USER: I would like a shared cab to get to Gallo's, hurry please.
SYSTEM: How many people are in your group?
USER: There are two people.
SYSTEM: Sorry, I didn't get that. could you please repeat?
USER: Come on! we are two people. two stupid bot.
SYSTEM: You want a shared ride for 2 people to Gallo's. Is that right?
USER: Yes, yes, that is right. Can you tell me how long the ride takes and it's cost?
SYSTEM: Your cab is confirmed and is coming for you right now. The ride duration is 32 minutes and costs $22.81.
USER: Oh yes, this is excellent. Thank you!

The text may then be converted into code using any one of JSON, phyton, CURL or Nodejs code, to create a first NLP object suitable for use as an input for the herein disclosed computer implemented method (here exemplified using phyton):

Import requests api_key = “<YOUR-API-KEY>” url =
“https://api.oneai.com/api/v0/pipeline” text = ‘[{“speaker”:“USER”,“utterance”:“...” headers =
{“api-key”: api key, “content-type”: “application/json”} payload = {“text”: text,
“input_type”:“conversation”

The user may then select NLP tasks (skills) that he would like to be executed on the text as well as a pipeline (hierarchy) of the tasks.

For example, the user may select having 1) emotions retrieved from the original text in order to understand the USER's satisfaction with the chatbot conversation, thereby generating a first subsequent NLP object (output) and 2) create a summary (second NLP object) from which entities are to be retrieved in order to quickly understand the essence of the conversation. In this case, the entity retrieval task is dependent on the second NLP object, namely the summary, which serves as an input for this NLP task.

Two text outputs and respective metadata outputs are thus created:
1. Original text with emotions (FIG. 3A):
   “USER I would like a shared cab to get to Gallo's, hurry please.
   SYSTEM How many people are in your group?
   USER There are two people.
   SYSTEM Sorry, I didn't get that. could you please repeat?
   USER Come on! we are two people. ANGERtwo.stupidbot.
   SYSTEM You want a shared ride for 2 people to Gallo's. Is that right?
   USER Yes, yes, that is right. Can you tell me how long the ride takes and it's
   cost? SYSTEM Your cab is confirmed and is coming for you right now. The ride duration is 32 minutes and costs $22.81.
   USER HAPPINESS Oh yes, this is excellent. HAPPINESS Thank you!”

With the metadata output:

| Type | Label | Span | Value |
|---|---|---|---|
| Emotion | Anger | 228.243 | two. stupid bot. |
| Emotion | Happiness | 520.546 | Oh yes, this is excellent. |
| Emotion | Happiness | 547.557 | Thank you! |

2. Summary with entities:
   “A shared cab is coming for ORGUSER to FACGallo's in TIME32 minutes and costs $ MONEY 22.81.”
With the metadata output:

| Type | Label | Span | Value |
|---|---|---|---|
| Entity | ORG | 27.31 | USER |
| Entity | FAC | 35.42 | Gallo's |
| Entity | TIME | 46.56 | 32 minutes |
| Entity | MONEY | 68.73 | 22.81 |

### Example 2—NLP tasks on HTML article

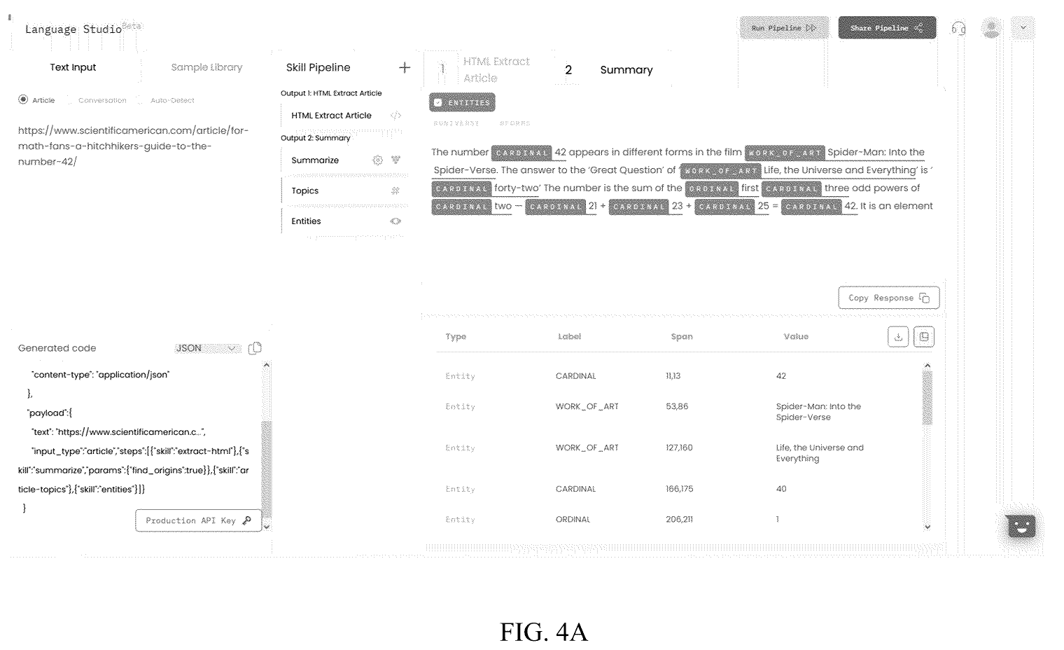

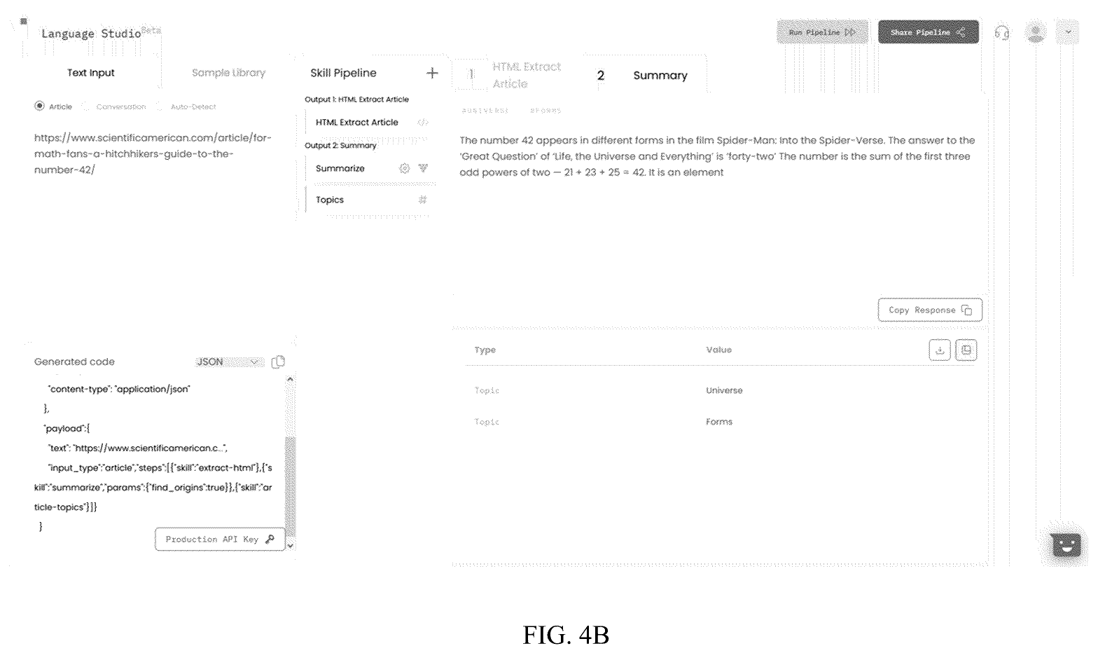

Reference is now made to FIG. 4A and FIG. 4B, which illustratively depict an optional pipeline of the herein disclosed computer implemented method for enabling streamlined text language processing utilizing a plurality of ML and/or NLP models for an HTML extracted article type document, according to some embodiments.

First a user may insert the text, in this case a link to an online article. For example:

https://www.scientificamerican.com/article/for-math-fans-a-hitchhikers-guide-to-the-number-42/The text may then be converted into code using any one of JSON, phyton, CURL or Node.j s code, to create a first NLP object suitable for use as an input for the herein disclosed computer implemented method (here exemplified using JSON):

{ “headers”: { “api-key”: “<YOUR-API-KEY>”, “content-type”: “application/json” },
“payload”:{ “text”: “https://www.scientificamerican.c...”,
“input_type”:“article”,“steps”:[{“skill”:“extract-html”}

The user may then select NLP tasks (skills) that he would like to be executed on the text as well as a pipeline (hierarchy) of the tasks.

For example, the user may select generating a summary (first NLP object) from which topics and entities are to be retrieved in order to quickly understand the essence of the article. In this case, both the identification of the topic and the entity retrieval tasks are dependent on the NLP object, namely the summary, which serves as an input for these NLP tasks.

As before, a text output and associated metadata (entities and forms) are created (FIG. 4A):

“The number CARDINAL42 appears in different forms in the film WORD OF ART Spider-Man: Into the Spider-Verse. The answer to the ‘Great Question’ of ‘WORK OF ARTLife, the Universe and Everything’ is ‘CARDINALforty-two’ The number is the sum of the ORDINALfirst CARDINALthree odd powers of CARDINAL CARDINALtwo CARDINAL21+CARDINAL23+CARDINAL25=CARDINAL42. It is an element”

With a list of metadata:

| Type | Label | Span | Value |
|---|---|---|---|
| Entity | CARDINAL | 11.13 | 42 |
| Entity | WORK_OF_ART | 53.86 | Spider-Man: Into |
| | | | the Spider-Verse |
| Entity | WORK_OF_ART | 127.160 | Life, the Universe |
| | | | and Everything |
| Entity | CARDINAL | 166.175 | 40 |
| Entity | CARDINAL | 206.211 | 1 |
| Entity | ORDINAL | 212.217 | 3 |
| Entity | CARDINAL | 232.235 | 2 |
| Entity | CARDINAL | 238.240 | 21 |
| Entity | CARDINAL | 243.245 | 23 |
| Entity | CARDINAL | 248.250 | 25 |
| Entity | CARDINAL | 253.256 | 42 |
| Topic | | | Universe |
| Topic | | | Forms |

The user may then decide that there is no need for the entities and that simply generating a summary (first NLP object) with topics is sufficient to obtain a quick understanding of the essence of the article and may therefore chose to remove the entities from the selected NLP tasks.

Accordingly, a new output is instantly and automatically generated (FIG. 3B):

“The number 42 appears in different forms in the film Spider-Man: Into the Spider-Verse. The answer to the ‘Great Question’ of ‘Life, the Universe and Everything’ is ‘forty-two’. The number is the sum of the first three odd powers of two — 21+23+25=42. It is an element.”

With associated metadata list:

| | | | |
|---|---|---|---|
| Type | Label | Span | Value |

| | |
|---|---|
| Topic | Universe |
| Topic | Forms |

It is understood to one with ordinary skill in the art that examples 1 and 2 are exemplary only, and that various other NLP tasks and hierarchies may be executed on various text documents in a streamlined and dynamic manner.

In the description and claims of the application, the words “include”, “have” and “comprises”, and forms thereof, are not limited to members in a list with which the words may be associated.

Unless otherwise defined, all technical and scientific terms used herein have the same meaning as commonly understood by one of ordinary skill in the art to which this disclosure pertains. In case of conflict, the patent specification, including definitions, governs. As used herein, the indefinite articles “a” and “an” mean “at least one” or “one or more” unless the context clearly dictates otherwise.

It is appreciated that certain features of the disclosure, which are, for clarity, described in the context of separate embodiments, may also be provided in combination in a single embodiment. Conversely, various features of the disclosure, which are, for brevity, described in the context of a single embodiment, may also be provided separately or in any suitable sub-combination or as suitable in any other described embodiment of the disclosure. No feature described in the context of an embodiment is to be considered an essential feature of that embodiment, unless explicitly specified as such.

Although stages of methods according to some embodiments may be described in a specific sequence, methods of the disclosure may include some or all of the described stages carried out in a different order. A method of the disclosure may include a few of the stages described or all of the stages described. No particular stage in a disclosed method is to be considered an essential stage of that method, unless explicitly specified as such.

Although the disclosure is described in conjunction with specific embodiments thereof, it is evident that numerous alternatives, modifications, and variations that are apparent to those skilled in the art may exist. Accordingly, the disclosure embraces all such alternatives, modifications, and variations that fall within the scope of the appended claims. It is to be understood that the disclosure is not necessarily limited in its application to the details of construction and the arrangement of the components and/or methods set forth herein. Other embodiments may be practiced, and an embodiment may be carried out in various ways.

The phraseology and terminology employed herein are for descriptive purpose and should not be regarded as limiting. Section headings are used herein to ease understanding of the specification and should not be construed as necessarily limiting.

While certain embodiments of the invention have been illustrated and described, it will be clear that the invention is not limited to the embodiments described herein. Numerous modifications, changes, variations, substitutions and equivalents will be apparent to those skilled in the art without departing from the spirit and scope of the present invention as described by the claims, which follow.

1. A computer implemented method comprising:
receiving an input from a user, the input comprising:
a text-containing document,
one or more user selected Natural Language Processing (NLP) tasks (skills) to be executed on the text-containing document; and
a user selected hierarchy of the selected NLP tasks, wherein the hierarchy of the user selected NLP tasks dictates an execution order and/or execution dependency between the selected NLP tasks;
executing the one or more selected NLP tasks by:
selecting one or more machine learning (ML) and/or NLP models for execution of each of the selected NLP tasks (skill),
generating a first NLP object based on the inputted text-containing document and the user selected hierarchy of selected NLP tasks,
generating one or more subsequent NLP object, using the first NLP object as an input;
wherein the first and the one or more subsequent NLP objects have a shared and standardized data structure and/or protocol comprising a collection of metadata items, wherein each metadata item comprises a) a type of annotation, and b) one or more metadata item features selected from: a span of the text-containing document upon which the metadata is applied, a primary value of the annotation, and one or more additional associated annotation values,
wherein each of the required selected ML and/or NLP models receive an NLP object as an input and wherein each of the required ML and/or NLP models outputs an NLP object;
aggregating the NLP objects resulting from execution of all NLP task considering their position in the execution hierarchy; and
generating one or more final outputs in a form of a modified text and/or in a form of a list of extracted metadata associated with the inputted text-containing document or with the modified text;
wherein dynamic changes in NLP task selection and hierarchy are executable without model building and without writing new code.

2. The method of claim 1, wherein the aggregating of the NLP objects comprises identifying shared and/or interdependent components, subcomponents and/or processing steps in the one or more required ML/NLP models.

3. The method of claim 1, wherein the aggregating of the NLP objects further comprises merging/unifying the shared and/or interdependent components, subcomponents and/or processing steps, to avoid repetition thereof.

4. (canceled)

5. The method of claim 1, wherein the source of the text containing document inputted is selected from a transcribed text, a paper, a bot chat, a one-pager, a business presentation, an article, a written conversation, a blog, a recorded and transcribed conversation, news, text message or any combination thereof.

6. The method of claim 1, wherein the one or more selected NLP tasks is selected from: creating a text summary, identifying highlights in the text-containing document, identifying emotions in the text-containing document, identifying sentiments in the text, identifying keywords, split text, clustering, topic extraction, entity detection, identifying, enhance transcription or any combination thereof.

7. The method of claim 1, wherein the one or more ML/NLP models is selected from Bidirectional Encoder Representations from Transformers (BERT), Robustly Optimized BERT Pretraining Approach (RoBERTa), GPT-3, ALBERT, XLNet, GPT2, StructBERT, Text-to-Text Transfer Transformer (T5), Efficiently Learning an Encoder that Classifies Token Replacements Accurately (ELECTRA), Decoding-enhanced BERT with disentangled attention (DeBERT) or any combination thereof.

8. The method of claim 1, wherein the modified text comprises text changes and/or metadata representations and/or vector representations.

9. The method of claim 8, wherein the text changes comprise text additions, text editions and/or text deletions.

10. The method of claim 8, wherein the metadata comprises labeling the inputted text-containing document or one or more spans thereof with one or more labels selected from: annotation name, annotation, span of the text-containing document upon which the metadata is applied, a primary value of the annotation, and one or more additional associated annotation values.

11. The method of claim 8, wherein the vector representations comprise embeddings and/or interference vectors.

12. (canceled)

13. A system comprising a processor, a display and a user interface configured to:
receive an input from a user, the input comprising:
a text-containing document,
one or more user selected Natural Language Processing (NLP) tasks (skills) to be executed on the text-containing document; and
a user selected hierarchy of the selected NLP tasks, wherein the hierarchy of the user selected NLP tasks dictates an execution order and/or execution dependency between the selected NLP tasks;
execute the one or more selected NLP tasks by generating generate NLP objects based on the inputted text-containing document and the user selected hierarchy of selected NLP tasks, wherein the NLP objects have a standardized data structure and/or protocol comprising a collection of metadata items,
wherein each metadata item comprises a) a type of annotation, and b) one or more metadata item features selected from: a span of the text-containing document upon which the metadata is applied, a primary value of the annotation, and one or more additional associated annotation values, and
generate one or more NLP outputs in a form of a modified text and/or a list of extracted metadata associated with the inputted text-containing document and/or the modified text;
wherein the system is configured to allow dynamic changes in NLP task selection and hierarchy without model building and without writing new code.

14. The system of claim 13, wherein the text-containing document is a conversation type text or an article type text.

15. The system of claim 13, wherein the text-containing document inputted is selected from a transcribed text, a paper, a bot chat, a one-pager, a business presentation, an article, a written conversation, a blog, a recorded and transcribed conversation, news, text message or any combination thereof.

16. The system of claim 13, wherein the one or more selected NLP tasks is selected from: creating a text summary, identifying highlights in thea text, identifying emotions in the text, identifying sentiments in the text, identifying keywords, split text, clustering, topic extraction, entity detection, identifying, enhance transcription or any combination thereof.

17. (canceled)

18. The system of claim 13, wherein the user interface comprises two windows, wherein a first of the two windows comprises an input-side and wherein a second of the two windows comprises an output-side.

19. The system of claim 18, wherein the input-side comprises a text input window, a generated code window and an NLP-task window.

20. The system of claim 18, wherein the output side-window comprises one or more output-sub-windows, wherein the one or more output-sub-windows comprise a text window and/or a list of extracted metadata-window.

21. The method of claim 1, wherein the standardized data structure and/or protocol enables invoking/chaining multiple skills on the text containing document with a single API call.

22. The system of claim 13, wherein the system is configured to invoke/chain multiple skills on the text containing document with a single API call.
